(19) United States
(12) Patent Application Publication
(10) Pub. No.: US 2006/0068195 A1
(43) Pub. Date: Mar. 30, 2006

(54) Electrically and thermally conductive carbon nanotube or nanofiber array dry adhesive

(76) Inventors: Arun Majumdar, Orinda, CA (US); Tao Tong, Albany, CA (US); Yang Zhao, Albany, CA (US); Lance Delzeit, Sunnyvale, CA (US); Ali Kashani, San Jose, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/133,780

(22) Filed: May 19, 2005

Related U.S. Application Data
(60) Provisional application No. 60/572,713, filed on May 19, 2004.
(60) Provisional application No. 60/612,048, filed on Sep. 21, 2004.

(51) Int. Cl. B32B 5/16; B32B 37/00; C04B 37/00

(52) U.S. Cl. 428/323; 156/325; 156/182

(57) ABSTRACT

A carbon nanostructure adhesive for adhering two surfaces together, including: an array of vertically aligned carbon nanostructures on a first surface; and a second surface positioned adjacent to the vertically aligned carbon nanostructures such that the vertically aligned carbon nanostructures adhere the first and second surfaces together by van der Waals forces.

### RELATED APPLICATIONS

The present application claims priority to U.S. provisional patent application Nos. 60/572,713 filed May 19, 2004, entitled Electrically and Thermally Conductive Carbon Nanotube or Nanofiber Array Dry Adhesive; and 60/612,048 filed Sep. 21, 2004, also entitled Electrically and Thermally Conductive Carbon Nanotube or Nanofiber Array Dry Adhesive.

### STATEMENT OF FEDERAL INTEREST

The present invention was funded by a grant from NASA Goddard Space Flight Center, Award Number 016815. The government has certain rights in this invention.

### TECHNICAL FIELD

The present invention relates to novel applications for carbon nanotubes and/or nanofibers.

### BACKGROUND OF THE INVENTION

Adhesives are typically wet and polymer based, and have low thermal and electrical conductivity. For many applications (including, but not limited to, electronics and semi-conductor assembly, micro-electro-mechanical systems (MEMS), and even future bio-mimicking wall-climbing robots) it would instead be desirable to provide an adhesive that is dry and detachable such that it is reusable. It would also be desirable to provide an adhesive that has high electrical and thermal conductivity to enhance electrical and/or thermal conduction across the bonding interface.

### SUMMARY OF THE INVENTION

The present invention provides a dry adhesive structure having improved thermal and electrical contact conductance. The present novel adhesive is made from carbon nanotube arrays or carbon nanofiber arrays. Such carbon nanotube arrays or carbon nanofiber arrays may optionally be made as follows.

The carbon nanostructures can be grown by chemical vapor deposition (CVD) method from a substrate surface (first surface). The substrate can be silicon, molybdenum, or other materials. An iron (Fe) layer can be used as the catalyst layer together with an aluminum (Al) and/or molybdenum (Mo) underlayer(s) to facilitate the growth. The gas feedstock is generally hydrocarbons, e.g., ethylene. The growth temperature may optionally range from 750° to 900° degrees Celsius. The density of the arrays can be controlled by the thicknesses of the catalyst layer and the underlayer(s). The height of the arrays can be controlled by the growth time. The carbon nanostructures are inherently adhered from the substrate from growth with the help of the underlayer that may optionally be made of aluminum, and/or molybdenum.

In one preferred aspect, the present invention provides a method of adhering two surfaces together with a carbon nanostructure adhesive, by: forming an array of vertically aligned carbon nanostructures on a first surface (i.e.: the “substrate surface”); and then positioning a second surface (i.e.: the “target surface”) adjacent to the vertically aligned carbon nanostructures such that the vertically aligned carbon nanostructures adhere the first and second surfaces together by van der Waals forces. In optional aspects of this method, the carbon nanotube arrays or nanofibers are deposited on the first surface by chemical vapor deposition. The density of the arrays may optionally be controlled by the thickness of a catalyst film. The height of the arrays can be controlled by the growth time.

The present carbon nanostructures preferably have a tower height of less than 30 μm, or more preferably, between 5 to 10 μm. In various embodiments, the carbon nanostructures are formed with a density of between 10¹⁰ to 10¹¹ nanostructures/cm².

In various embodiments, the carbon nanostructures are attached (adhered) to the first surface (substrate surface) by an underlayer between the bottom ends of the carbon nanostructures and the first surface (substrate surface). As stated above, this underlayer may optionally be made of aluminum, and/or molybdenum.

In another preferred aspect, the present invention provides a carbon nanostructure adhesive structure, including: a first object; an array of vertically aligned carbon nanostructures on a surface of the first object; a second object; and an array of vertically aligned carbon nanostructures on a surface of the second object. The surfaces of the first and second objects are positioned adjacent to one another such that the vertically aligned carbon nanostructures on the surface of the first object adhere to the vertically aligned carbon nanostructures on the surface of the second object by van der Waals forces.

In another preferred aspect, the present invention provides a method of forming a two-sided carbon nanostructure adhesive structure, by: forming an array of vertically aligned carbon nanostructures on a first surface of an object; and forming an array of vertically aligned carbon nanostructures on a second surface of the object, wherein the first and second surfaces are opposite sides of the object.

In yet another preferred aspect, the present invention provides a two-sided carbon nanostructure adhesive structure, including: an object; an array of vertically aligned carbon nanostructures on a first surface of the object; and an array of vertically aligned carbon nanostructures on a second surface of the object, wherein the first and second surfaces are opposite sides of the object. This embodiment is particularly advantageous in adhering multiple surfaces (e.g.: different objects) together.

One advantage of the present adhesive is that it provides an adhesive that is dry. In contrast, existing adhesives are mostly wet (organic polymer-based), and difficult to handle. Furthermore, existing polymeric-based adhesives are particularly difficult to handle in vacuum (outgassing) and/or low temperature (brittle and outgassing) or elevated temperature (pyrolysis) conditions. These disadvantages are considerably overcome by carbon nanotube/nanofiber structures. They are vacuum compatible, cryogenic temperature compatible, and can also sustain an elevated temperature up to 200-300° C. in the oxygenic environment and up to at least 900° C. in vacuum environment.

Yet another advantage of the present adhesive is that it can be used at very low (i.e., cryogenic) temperatures. In contrast, existing adhesives tend to become brittle at such low temperatures.

Further advantages of the present system of using carbon nanotubes in an adhesive structure also include the fact that carbon nanotubes have very good mechanical properties such as very high Young's modulus and very high tensile, bending strengths.

Yet another advantage of the present adhesive is that it increases the levels of thermal and electrical conductance between bonding surfaces. This is especially useful in electrical applications and applications that need thermal management, e.g., chip cooling. As stated above, the present dry adhesive operates by van der Waals forces acting at the distal ends of the carbon nanostructures, thereby holding different objects or surfaces together. Such carbon nanotubes or carbon nanofibers provide excellent thermal and electrical conductance. In contrast, existing wet adhesives tend to exhibit low thermal and electrical conductance between bonding surfaces.

### BRIEF DESCRIPTION OF THE DRAWINGS

FIG. 1A is a side elevation view of a first surface (i.e.: a substrate surface which nanotubes are grown from) with an array of carbon nanostructures disposed thereon, prior to bonding to a second surface.

FIG. 1B is a side elevation view corresponding to FIG. 1A, after the first and second surfaces have been bonded together (by the carbon nanostructures on the first surface).

FIG. 2A is a side elevation view of first and second surfaces, each with an array of carbon nanostructures disposed thereon, prior to bonding the surfaces together.

FIG. 2B is a side elevation view corresponding to FIG. 2A, after the first and second surfaces have been bonded together (by the carbon nanostructures on both surfaces).

FIG. 3A is a close up perspective view of first and second bonding surfaces in FIG. 2A, each with an array of carbon nanostructures deposited thereon.

FIG. 3B is a close up sectional side elevation view of the first and second bonding surfaces of FIG. 3A placed together, showing interpenetration of the carbon nanostructures thereon.

FIG. 4A is a sectional side elevation view of a first object having an array of carbon nanostructures disposed on each of its opposite sides (prior to bonding between two other objects).

FIG. 4B is a side elevation view corresponding to FIG. 4A, after the objects have been bonded together.

FIG. 5 is an illustration of experimentally measured adhesion strength in the normal direction for various embodiments of the present adhesive structure under cyclic loading.

FIG. 6 is an illustration of experimentally measured adhesion strength in the shear direction for the various embodiments of the adhesive structure shown in FIG. 5, under cyclic loading.

FIG. 7 is an illustration of experimentally measured contact adhesion strength and contact resistivity for an embodiment of the present adhesive structure.

FIG. 8 is an illustration of experimentally measured electrical resistance properties for various embodiments of the present adhesive structure, with the bonding surfaces pushed together under various pressures.

FIG. 9 is an illustration of measured adhesion strength under cyclic loading for various embodiments of the adhesive structure as shown in FIG. 2B (i.e.: where carbon nanotubes are positioned on two opposite surfaces that are bonded together).

### DETAILED DESCRIPTION OF THE DRAWINGS

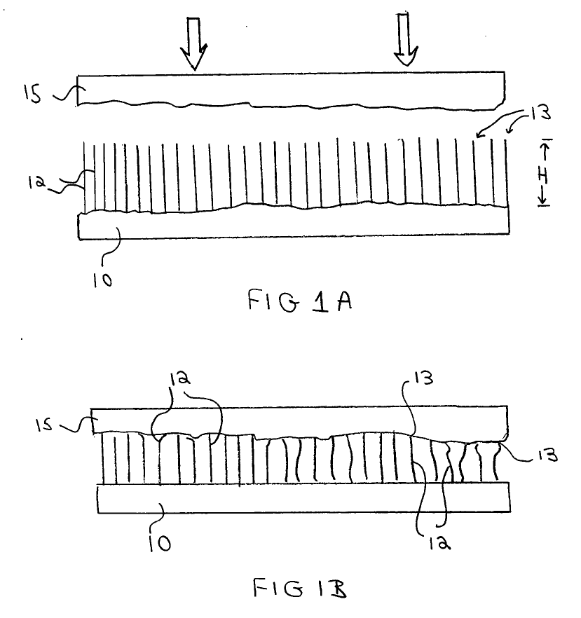

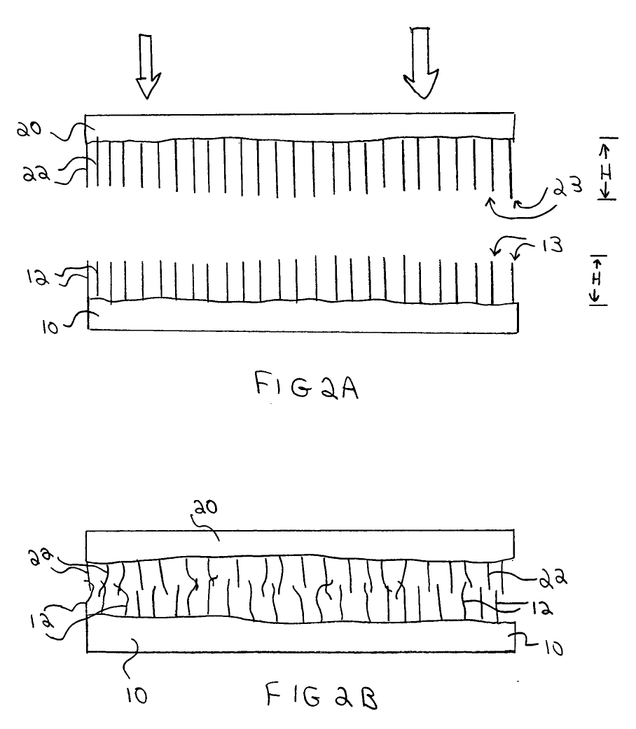

FIG. 1A shows a first bonding surface 10. An array of carbon nanostructures 12 are formed on surface 10 and extend generally vertically therefrom as shown. Carbon nanostructures 12 may be carbon nanotubes or carbon nanofibers. In embodiments where the nanostructures are carbon nanotubes, such nanotubes may be single-walled nanotubes or multi-walled nanotubes. The array of carbon nanostructures 12 may be formed onto surface 10 by standard chemical vapor deposition techniques, or by any other technique. In preferred embodiments, the density of the array of carbon nanotubes may be controlled by thickness of the catalyst layer and the underlayer(s). In optional preferred embodiments, iron is used as the catalyst film.

Next, as shown in FIG. 1B, a second surface 15 is placed on top of the array of carbon nanostructures 12. Thus, surface 15 is brought into contact with top ends 13 of carbon nanostructures 12. In accordance with the present invention, the interaction of van der Waals forces acting between top ends 13 of carbon nanostructures 12 and surface 15 will operate to bond surfaces 10 and 15 together. This bonding is due to the fact that the present carbon nanostructures 12 have a feature dimension small enough and spatial density high enough such that van der Waals interaction between carbon nanostructures 12 and surface 15 is significant rather than capillary forces.

As can be seen in FIG. 1B, some of the individual carbon nanostructures 12 may be bent slightly or even tangled around adjacent carbon nanostructures 12 (especially at their top ends 13) when surface 15 is positioned adjacent thereto. Such bending or tangling may be due to inherent surface unevenness in surface 15. In addition, surface 10 may also have slight unevenness at the location where carbon nanostructures 12 are formed thereon. Such bending or tangling at top ends 13 may also be due to differences in height among the various individual carbon nanostructures 12. The present inventors have experimentally determined that such minor microscopic variations in surface flatness on either or both of surfaces 10 and 15 do not negatively affect the performance of the present dry adhesive.

The present inventors have also experimentally determined that the present adhesive structure may exhibit enhanced bonding effectiveness when the tower height H of the individual carbon nanostructures 12 is less than 30 μm in length.

The present inventors have further experimentally determined that the present adhesive structure may exhibit enhanced bonding effectiveness when the tower height H of the carbon nanostructures 12 is specifically between 5 to 10 μm.

In various methods of manufacturing the present adhesive system, carbon nanostructures 12 may be formed onto surface 10 by chemical vapor deposition (nanotubes), or by plasma enhanced chemical vapor deposition (nanofibers). However, the present invention is not so limited. Rather, any suitable conventional technique may be used to form an array of carbon nanostructures 12 on a surface 10.

In various methods of manufacturing the present invention, carbon nanostructures 12 are formed onto surface 10 with a density of between 10¹⁰/cm² to 10¹¹/cm². It is to be understood, however, that such densities are merely exemplary, and that the present invention is not so limited.

In various methods of manufacturing the present invention, carbon nanostructures 12 are formed onto surface 10 with an underlayer therebetween. Such underlayer may comprise aluminum. The present inventors have experimentally determined that the present adhesive structure may exhibit enhanced bonding effectiveness when the underlayer comprises molybdenum. Specifically, the use of molybdenum assists in holding the bottom ends of carbon nanostructures 12 onto surface 10. This prevents carbon nanostructures 12 from separating from surface 10 if surfaces 10 and 15 are pulled in opposite directions after bonding.

In an alternate embodiment of the invention shown in FIGS. 2A and 2B, an array of carbon nanostructures 22 is formed onto surface 20. (Carbon nanostructures 22 on surface 20 may be formed in exactly the same manner as carbon nanostructures 12 were formed on surface 10, as was explained above).

In this embodiment of the present invention, surfaces 10 and 20 are brought together as shown in FIG. 2B. The action of van der Waals forces between carbon nanostructures 12 and 22 operates to bond surfaces 10 and 20 together.

As can be seen in FIG. 2B, some of the individual carbon nanostructures 12 and 22 may be bent slightly or even tangled around adjacent carbon nanostructures 12 and 22 (especially at their respective top ends 13 and 23) when surfaces 10 and 20 are brought together. Such bending or tangling may be due to inherent surface unevenness in surfaces 10 and 20, and also be due to differences in height among the various individual carbon nanostructures 12 and 22.

As stated above, the present inventors have experimentally determined that minor microscopic variations in surface flatness on surfaces 10 and 20, and minor differences in tower height H among carbon nanostructures 12 and 22 do not negatively affect the performance of the present dry adhesive.

Moreover, in the specific embodiment of the invention shown in FIG. 2B, the top ends of carbon nanostructures 12 and 22 may interpenetrate, entangle or wrap around one another. This may further provide a “hook and loop” (e.g.: “Velcro”) type of fastening effect, further enhancing the bonding of surfaces 10 and 20 together.

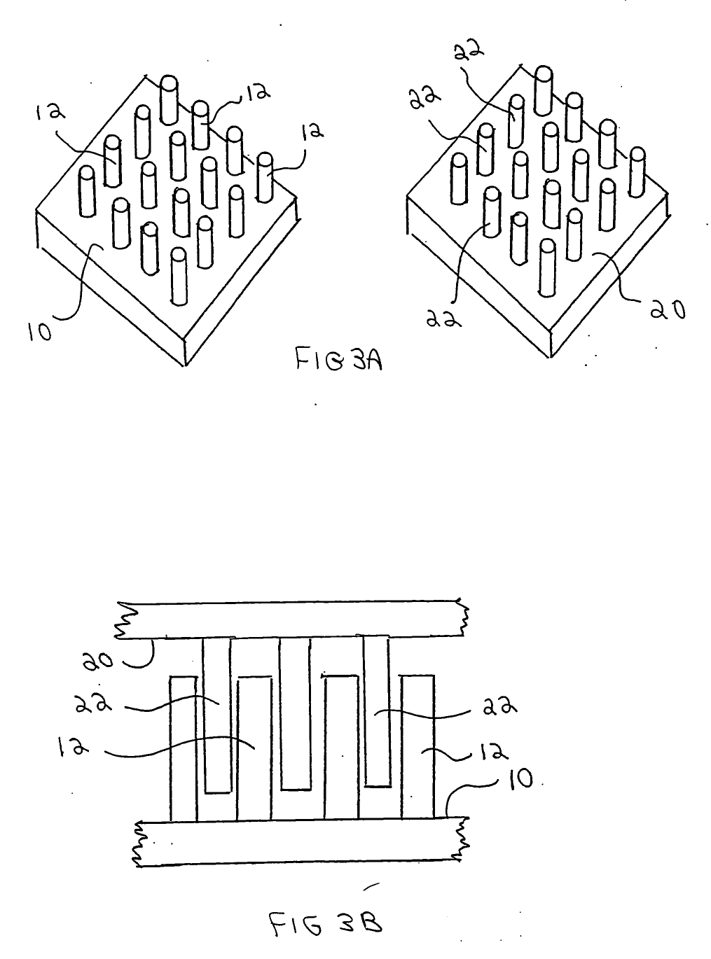

FIG. 3A shows a close up perspective view of first and second bonding surfaces 10 and 20 corresponding to FIG. 2A, each with an array of carbon nanostructures 12 and 22 deposited thereon.

FIG. 3B shows a close up view corresponding to FIG. 2B, with first and second bonding surfaces 10 and 20 positioned together, showing interpenetration of the carbon nanostructures 12 and 22 thereon. The degree of such interpenetration has been exaggerated for illustration purposes. As was explained above, such interpenetration of carbon nanostructures 12 and 22 may only consist of slight interpenetration of the top ends 13 and 23 of carbon nanostructures 12 and 22. In addition, the “pillar-like” nature of carbon nanostructures 12 and 22 has been exaggerated in FIGS. 3A and 3B for ease of illustration purposes. Typically, carbon nanostructures 12 and 22 more closely resemble long string-like structures.

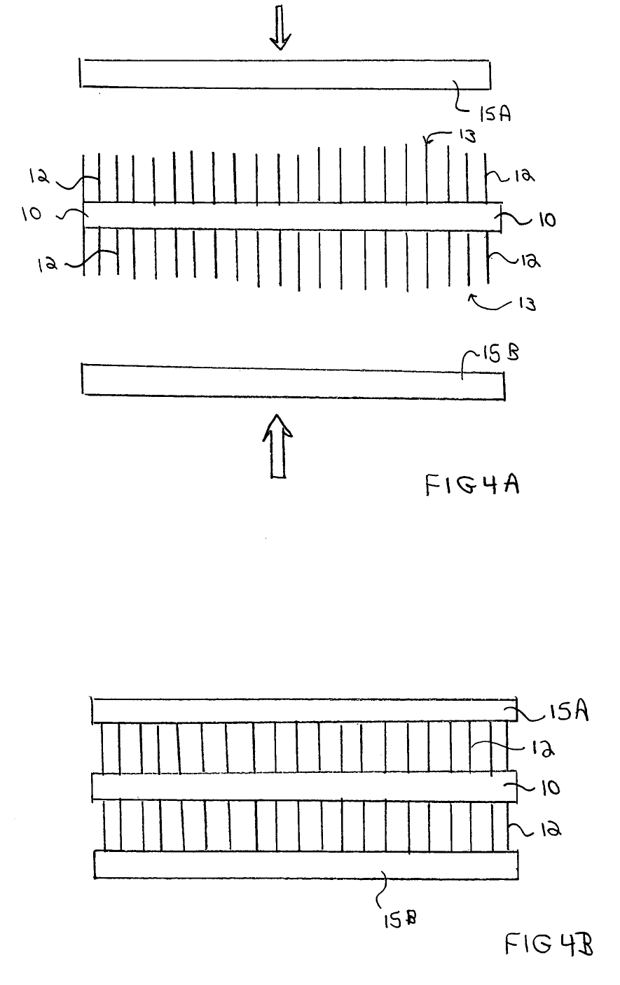

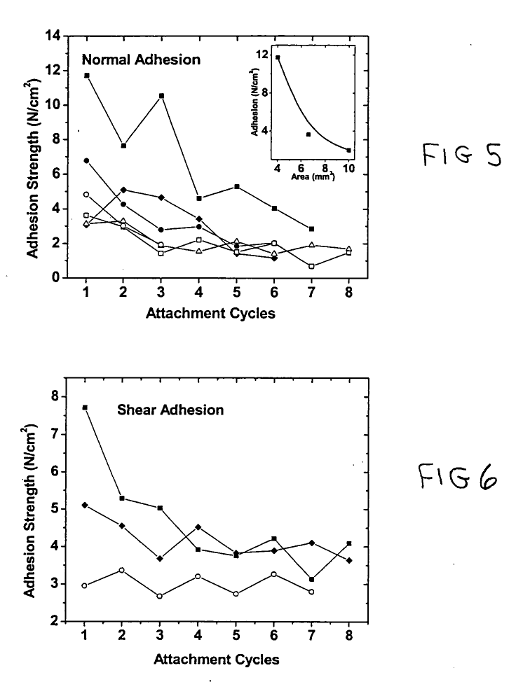

FIG. 4A shows a single bonding surface 10 with an arrays of carbon nanostructures 12 disposed on each of its opposite sides. Bonding surface 10 is received between two objects (i.e.: surfaces 15A and 15B). As was explained above, the interaction of van der Waals forces between the top ends 13 of carbon nanostructures 12 and each of surfaces 15A and 15B will operate to bond surfaces 15A and 15B together as shown in FIG. 4B. It is to be understood that the embodiment of surface 10 shown in FIGS. 4A and 4B may also be used to bond together any surfaces, including surfaces similar to 20 (i.e.: surfaces with carbon nanostructures thereon). This embodiment of the present invention is particularly useful in bonding together thin, flat electronic components due to the high electrical and thermal conductivity of the structure.

In various embodiments, each or all of surfaces 10, 15 and 20 may be silicon wafers, or they may be membranes. The present invention is not limited to any particular embodiment.

### Experimental Results

The present inventors have successfully fabricated the adhesive structures illustrated in FIGS. 1A to 3B. In one experiment, the present carbon nanotube assembly was formed by chemical vapor deposition (CVD) at a growth temperature of 750° C. with a feedstock of ethylene on highly Boron doped (10¹⁹ cm⁻³) silicon wafers. Before growth, the wafer surface was sputter-deposited with an underlayer of a ˜10 nm thick aluminum film followed by sputter-deposition of a ˜10 nm thick catalyst layer of iron. The aluminum underlayer was used to tailor the nanotubes growth and to enhance the nanotubes adhesion to the substrate. The growth time varied from 30 seconds to 10 minutes resulting in nanotube tower heights varying from a few micrometers to more than 100 micrometers.

These properties of these adhesive structures were tested both in a normal direction, and in a shear direction. Specifically, to investigate the adhesive properties of multi-walled nanotube arrays grown on Si substrates, they were pressed against the target surface with a preload of around 1 Kg. Next a lab balance was used to measure adhesion forces in both normal and shear directions.

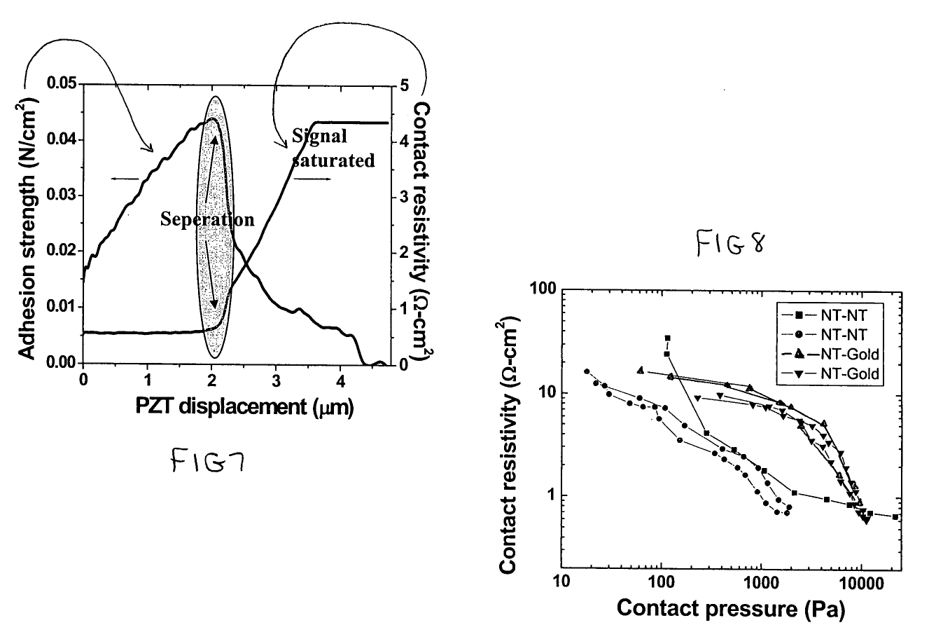

FIGS. 5 and 6 show the measured maximum normal and shear adhesion forces of he multi-walled nanotube arrays on various contacting surfaces. The carbon nanotubes in the tests were as-grown with tower heights ranging from 5 to 10 μm.

The target surfaces in FIG. 5 are illustrated as follows:
(a) glass (microscope slide)—4 mm² (solid square)
(b) glass—6 mm² (open square)
(c) gold (evaporated on Si)—4 mm² (solid circle)
(d) parylene (evaporated on Si)—7 mm² (solid diamond)
(e) GaAs—7.8 mm² (open triangle),
(f) Si—5 mm² (open circle)

The insert in FIG. 5 represents the inverse dependence of adhesion strength on contact area generalized for the glass samples.

The target surfaces in FIG. 6 are illustrated as follows:
(a) glass (microscope slide)—8 mm² (solid square)
(b) parylene—8 mm² (solid diamond)
(c) Si—8 mm² (open circle)

As can be seen in FIG. 5, the maximum measured adhesive strength in the normal direction was 11.7 N/cm² to a glass surface with an apparent area of 4 mm², and as can be seen in FIG. 6, an adhesive strength in shear of 7.8 N/cm² to a glass surface with an apparent area of 8 mm².

The present inventors have experimentally determined that tower heights of less than 301 μm show considerable adhesion, with the best results recorded at tower heights between 5 to 10 μm.

Before growth, the wafer surface was sputter-deposited with an underlayer of a ˜10 nm thick aluminum film followed by sputter-deposition of a ˜10 nm thick catalyst layer of iron. The aluminum underlayer tailored the nanotubes growth and enhanced the adhesion of the nanotubes to the substrate. The growth time varied from 30 seconds to 10 minutes resulting in nanotube tower heights varying from a few micrometers to more than 100 micrometers.

The addition of a molybdenum underlayer to the catalyst layer was found to improve the adhesion of multi-walled nanotubes 12 to surface 10.

In various experiments, a four terminal scheme was used to simultaneously measure the electrical contact conductance of the interface. Specifically, two electrodes were arranged on the back of each of surfaces 10 and 15. A constant current was applied through surfaces 10 and 15 by one set of electrodes, and the voltage drop was measured through surfaces 10 and 15 by another set of electrodes. Thus, contact and wire resistances were eliminated.

The electrical contact conductance of the multi-walled nanotube adhesive was measured to be as high as 50 Siemens per cm². Nanotube arrays covering surfaces of ˜2 mm², ˜4 mm², ˜6 mm² and ˜8 mm² were tested. The contact resistances were found to be on the order of 1 Ohm, showing no significant dependence upon contact area.

FIG. 7 is an illustration of experimentally measured contact adhesion strength and contact resistivity for an embodiment of the present invention. As can be seen, the resistivity tends to remain constant right up to the point of separation between the bonding surfaces. The bonding surfaces separate from one another at a displacement of about 21 μm (as measured experimentally by PZT displacement).

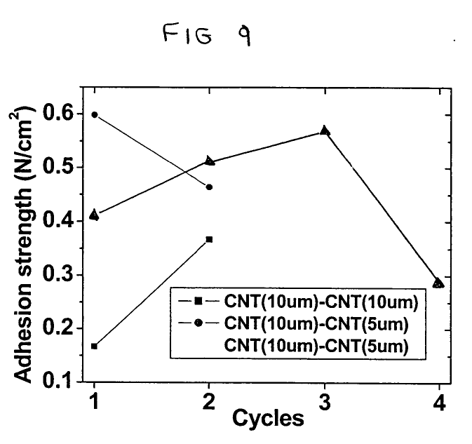

FIG. 8 is an illustration of experimentally measured electrical resistance properties for various embodiments of the present adhesive. As can be seen, resistivity tends to drop when the bonding surfaces are pushed together under greater pressures.

FIG. 9 is an illustration of measured adhesion strength under cyclic loading for various embodiments of the adhesive structure shown in FIG. 2B (i.e.: where carbon nanotubes are positioned on two opposite surfaces that are bonded together). As can be seen, the measured maximum adhesive strength in the normal direction was ˜0.6 N/cm² between two short carbon nanotube arrays. The bonding mechanism between the two arrays is still van der Waals force, with potentially some mechanical entangling between nanotubes (velcro-like) from the two surfaces as well.

The present inventors have calculated that: With multi-wall diameters around 20 nanometers and an aerial density around 10¹⁰ nanotubes/cm², an estimate based on the Johnson Kendall-Roberts (JKR) theory of elastic contact and surface adhesion suggests it is possible to generate adhesive strengths more than 100 N/cm² due to van der Waals attraction, assuming all the nanotubes point upward and make contact with a target surface. As has been experimentally observed, the present adhesive performs exceedingly well.

What is claimed is:

1. A method of adhering two surfaces together with a carbon nanostructure adhesive, comprising:
forming an array of vertically aligned carbon nanostructures on a first surface; and
positioning a second surface adjacent to the vertically aligned carbon nanostructures such that the vertically aligned carbon nanostructures adhere the first and second surfaces together.

2. The method of claim 1, wherein the vertically aligned carbon nanostructures adhere the first and second surfaces together by van der Waals forces between the vertically aligned carbon nanostructures and the second surface.

3. The method of claim 1, further comprising:
forming an array of vertically aligned carbon nanostructures on the second surface.

4. The method of claim 3, wherein the vertically aligned carbon nanostructures adhere the first and second surfaces together by van der Waals forces between the vertically aligned carbon nanostructures on each of the first and the second surfaces.

5. The method of claim 1, wherein the carbon nanostructures are carbon nanotubes.

6. The method of claim 1, wherein the carbon nanostructures are carbon nanofibers.

7. The method of claim 1, wherein the carbon nanostructures have a tower height of less than 30 μm.

8. The method of claim 7, wherein the carbon nanostructures have a tower height of between 5 to 10 μm.

9. The method of claim 1, wherein the carbon nanostructures are formed onto the first surface with a density of between 10¹⁰/cm² to 10¹¹/cm².

10. The method of claim 1, wherein the carbon nanostructures are formed onto the first surface by chemical vapor deposition.

11. The method of claim 1, wherein the carbon nanostructures are attached to the first surface by an underlayer therebetween, and wherein the underlayer comprises aluminum.

12. The method of claim 1, wherein the carbon nanostructures are attached to the first surface by an underlayer therebetween, and wherein the underlayer comprises molybdenum.

13. A method of forming a two-sided carbon nanostructure adhesive structure, comprising:
forming an array of vertically aligned carbon nanostructures on a first surface of an object; and
forming an array of vertically aligned carbon nanostructures on a second surface of the object, wherein the first and second surfaces are opposite sides of the object.

14. The method of claim 13, wherein the object is a wafer.

15. The method of claim 13, wherein the object is a membrane.

16. The method of claim 13, wherein the carbon nanostructures are carbon nanotubes.

17. The method of claim 13, wherein the carbon nanostructures are carbon nanofibers.

18. The method of claim 13, wherein the carbon nanostructures have a tower height of less than 30 μm.

19. The method of claim 18, wherein the carbon nanostructures have a tower height of between 5 to 10 μm.

20. The method of claim 14, wherein the carbon nanostructures are formed onto the first surface with a density of between 10¹⁰/cm² to 10¹¹/cm².

21. A carbon nanostructure adhesive structure, comprising:
a first object;
an array of vertically aligned carbon nanostructures on a surface of the first object;
a second object; and
an array of vertically aligned carbon nanostructures on a surface of the second object, wherein the surfaces of the first and second objects are positioned adjacent to one another such that the vertically aligned carbon nanostructures on the surface of the first object adhere to the vertically aligned carbon nanostructures on the surface of the second object by van der Waals forces.

22. The structure of claim 21, wherein the carbon nanostructures are carbon nanotubes.

23. The structure of claim 21, wherein the carbon nanostructures are carbon nanofibers.

24. The structure of claim 21, wherein the carbon nanostructures have a tower height of less than 30 μm.

25. The structure of claim 24, wherein the carbon nanostructures have a tower height of between 5 to 10 μm.

26. The structure of claim 21, wherein the carbon nanostructures on the surfaces of the first and second objects with a density between 10¹⁰/cm² to 10¹¹/cm².

27. The structure of claim 21, wherein the carbon nanostructures are attached to the first surface by an underlayer therebetween, and wherein the underlayer comprises aluminum.

28. The structure of claim 21, wherein the carbon nanostructures are attached to the first surface by an underlayer therebetween, and wherein the underlayer comprises molybdenum.

29. A two-sided carbon nanostructure adhesive structure, comprising:
an object;
an array of vertically aligned carbon nanostructures on a first surface of the object; and
an array of vertically aligned carbon nanostructures on a second surface of the object, wherein the first and second surfaces are opposite sides of the object.

30. The structure of claim 29, wherein the object is a wafer.

31. The structure of claim 29, wherein the object is a membrane.

32. The structure of claim 29, wherein the carbon nanostructures are carbon nanotubes.

33. The structure of claim 29, wherein the carbon nanostructures are carbon nanofibers.

34. The structure of claim 29, wherein the carbon nanostructures have a tower height of less than 30 μm.

35. The structure of claim 34, wherein the carbon nanostructures have a tower height of between 5 to 10 μm.

36. The structure of claim 29, wherein the carbon nanostructures have a density of between 10¹⁰/cm² to 10¹¹/cm².

37. The structure of claim 29, wherein the carbon nanostructures are each attached to the first and second surfaces by an underlayer therebetween, and wherein the underlayer comprises aluminum.

38. The method of claim 29, wherein the carbon nanostructures are each attached to the first and second surface by an underlayer therebetween, and wherein the underlayer comprises molybdenum.

39. The method of claim 4, wherein the vertically aligned carbon nanostructures on each of the first and the second surfaces interpenetrate one another.

40. The method of claim 21, wherein the vertically aligned carbon nanostructures on each of the first and the second objects interpenetrate one another.
